(19) United States
(12) Patent Application Publication
(10) Pub. No.: US 2003/0236810 A1
(43) Pub. Date: Dec. 25, 2003

(54) Big number multiplication apparatus and method

(75) Inventors: Priya N. Vaidya, Belchertown, MA (US); Minda Zhang, Westford, MA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/183,722

(22) Filed: Jun. 25, 2002

(51) Int. Cl. G06F 7/52

(52) U.S. Cl. 708/620

(57) ABSTRACT

A multiplication apparatus and system may include a multiplicand buffer to hold a digit of a multiplicand, a multiplier buffer to hold a digit of a multiplier, and a result buffer to hold a carry-free multiplied and accumulated result of the multiplicand and a plurality of reverse ordered digits included in the multiplier. An article, including a machine-accessible medium, may contain data capable of causing a machine to implement a multiplication method, including selecting a multiplicand plurality of digits, reversing the order of a selected multiplier plurality of digits to provide a reversed plurality of digits, and multiplying and accumulating the multiplicand plurality of digits and the reversed plurality of digits to provide a multiplication result.

### TECHNICAL FIELD

Embodiments of the present invention relate generally to apparatus and methods used for computational arithmetic. More particularly, embodiments of the present invention relate to apparatus and methods used to multiply large numbers.

### BACKGROUND INFORMATION

Whether modeling laminar air flow, forecasting the weather, or predicting the occurrence of various natural phenomena, mathematics plays an important role in our growing understanding of the world. Computers allow scientists to perform vast numbers of computations very quickly. However, even with the fastest computers, it may require days for a computer to conduct the desired analysis.

Standard personal computers (PCs) are quite capable of quickly manipulating integer quantities (e.g., 3*4), but are relatively slow when it comes to dealing with real numbers (e.g. 3.01*4.1). Therefore, scientists usually rely on larger workstations to do their number crunching. Such workstations are typically much faster than desktop PCs when used for this purpose.

One solution to increasing the speed of real number processing is to use integers instead. For example, to compute 3.01*4.1, the answer may be obtained using the integers 3010*4100, keeping track of the scaled values. While integer math techniques are useful for computer graphics, where precision and range may not be critical, they are not suitable for most scientific applications.

As more powerful PCs have become available, some of the processors within them have been constructed to provide Single Instruction, Multiple Data (SIMD) commands which permit conducting several similar mathematical computations in parallel. Examples include the Intel® SSE and SSE2 instructions available on the Intel® Pentium® III and Pentium® IV processors, which permit the multiplication of four numbers simultaneously. Programs that support these instructions can potentially run much more quickly.

However, even with the availability of SIMD instructions, there are numbers which are too large too be easily accommodated by the registers in a microprocessor. For example, the multiplication of big numbers is relied upon heavily in cryptographic applications, particularly public-key cryptography. The importance of such systems has risen rapidly with the growth of the Internet, as they may be used to provide the basis for secure information exchange. The multiplication of big numbers is also important in scientific and research applications where extreme accuracy is important.

Assuming that any integer larger than a target machine's register size is defined as a “big number”, the implementation complexity of big number multiplication is caused mainly by carry propagation. Big number multiplication complicates the machine's execution pipeline because several multiplications that fit within the target machine register size usually need to be scheduled.

For example, assume that

$$A = {\sum }_{i = 0}^{n - 1} {a}_{i} {Z}^{i}$$

is a multiplicand,

$$B = {\sum }_{i = 0}^{n - 1} {b}_{i} {Z}^{i} is a$$

multiplier, aᵢ and bᵢ are two 32-bit integers, Z=2^{k}, and k=32 (for a 32-bit microprocessor). As the multiplication of A*B is processed, the partial products aᵢbₖ₋ᵢ must be computed several times. In a practical implementation, each multiplication produces a 64-bit integer, stored in two 32-bit registers. The carry resulting from the summation of any two of these 64-bit values propagates throughout the entire procedure, breaking the execution pipeline in a typical target machine multiplication unit. The inability to maintain a continuous data feed into the pipeline causes a severe performance penalty.

### BRIEF DESCRIPTION OF THE DRAWINGS

FIG. 1 is an exemplary pseudo-code listing of a method of multiplication according to an embodiment of the invention;

FIG. 2 is an exemplary diagram of two numbers being multiplied according to an embodiment of the invention;

FIG. 3 is a block diagram of an apparatus, a system, and an article according to various embodiments of the invention; and

FIG. 4 is a flow diagram of a method of multiplication according to an embodiment of the invention.

### DETAILED DESCRIPTION OF EMBODIMENTS OF THE INVENTION

In the following detailed description of embodiments of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to understand and implement them. Other embodiments may be utilized and derived therefrom, such that structural and logical substitutions and changes may be made without departing from the scope of the present disclosure. The following detailed description, therefore, is not to be taken in a limiting sense, and the scope of various embodiments of the invention is defined only by the appended claims, along with the fall range of equivalents to which such claims are entitled.

Herein is described a new method of big number multiplication, one that targets the native SIMD-MAC (multiply and accumulate) instruction capability of some processors, such as the Intel® Pentium® IV processor. To simplify the description of the method without losing generality, assume two 64-bit registers (e.g., A and B) are used to store integers for a multiplicand and multiplier, respectively. Further, assume A and B are both partitioned into four 16-bit fields, i.e. A=[a₃|a₂|a₁|a₀], and B=[b₀|b₁|b₂|b₃], with aᵢ and bⱼ each being 16 bits. Finally, assume the existence of an accumulator register (M) and a result register (R), each being 64-bit registers. Those skilled in the art will realize that a SIMD_MAC instruction may be used to compute R=SIMD_MAC(M,A,B)=M+a₃*b₀+a₂*b₁+a₁*b₂+a₀*b₃. This concept of partitioned and reversed order multiplication can be expanded to produce a multiplication method (using multiply and accumulate instructions) which requires no accommodation for explicit carry operations.

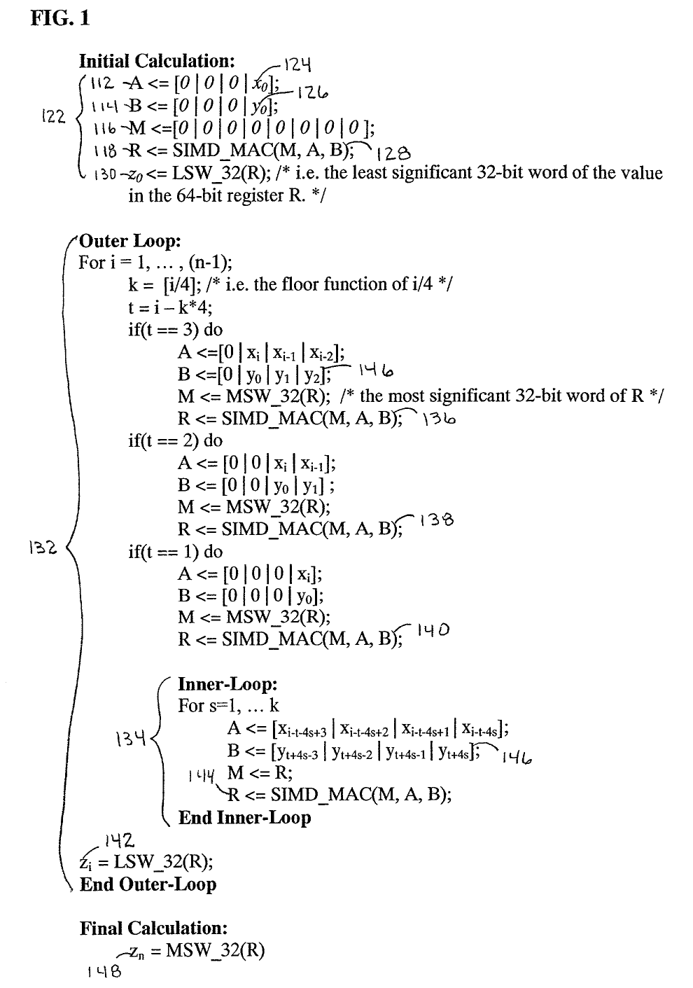

For example, to fully utilize the execution parallelism offered by the SIMD_MAC instruction, a more general scenario may be considered. FIG. 1 is an exemplary pseudo-code listing describing a method of multiplication according to an embodiment of the invention. In one embodiment, it may be assumed that buffers A 112 and B 114 are used to store a multiplicand X and multiplier Y, respectively, although the scope of the invention is not limited in this respect. It may also be assumed that buffer M 116 is an accumulator, that buffer R 118 is a temporary result buffer, and that the result of the multiplication of X and Y is stored in the overall result buffer Z. The multiplicand X may be partitioned as X=[xₙ₋₁|xₙ₋₂|xₙ₋₃|xₙ₋₄| . . . x₃|x₂|x₁|x₀], and the multiplier Y may be partitioned as Y=[yₙ₋₁|yₙ₋₂|yₙ₋₃|yₙ₋₄| . . . |y₃|y₂|y₁|y₀], where n=the number of digits in the multiplicand X and the multiplier Y. For this example, the components xᵢ, yᵢ may each be 16-bits in size, although the invention is not limited in this respect. The output Z may be partitioned as Z=[zₙ|zₙ₋₁|zₙ₋₂|zₙ₋₃| . . . |z₃|z₂|z₁|z₀], where each component zᵢ may be 32-bits in size, although the invention is not limited in this respect. It should be noted that the term “buffer” may be considered equivalent to a data register of arbitrary size, although the scope of the invention is not limited in this respect.

The pseudo-code of FIG. 1, which describes one example of a method of implementing an embodiment of the invention, includes an initial calculation portion 122, wherein the least significant digits of the multiplicand and multiplier 124, 126 may be multiplied and accumulated, perhaps by using a SIMD_MAC instruction 128, and stored in the result buffer R 118. Then, the least significant digit of the overall result (i.e., z₀ 130), may be determined by taking the least significant 32-bit word of the temporary result found in buffer R 118.

Next, several iterations are made through an outer loop 132 and an inner loop 134. In the outer loop 132, each of the other digits of the overall result Z, with the exception of the most significant digit zₙ, may be calculated in order from least significant to most significant (i.e. z₁,z₂, . . . zₙ₋₃,zₙ₋₂,zₙ₋₁). In each case, progressively packed partial products of the multiplicand X digits and the multiplier Y digits (e.g., xᵢ*y₀;xᵢ,xᵢ₋₁*y₀,y₁; etc.) may be multiplied and accumulated, again, possibly using one or more SIMD_MAC instructions 136, 138, 140.

Finally, the inner loop 134 may be executed as a part of calculating the digits zᵢ 142 of the overall result. In one particular embodiment, the purpose of the inner loop may be to calculate partial products 144 which can be used during the execution of the outer loop 132, although the scope of the invention is not limited in this respect. It should be noted, in this particular embodiment, that during the execution of the outer loop 132 and the inner loop 134, the order of the partitioned digits in the multiplier Y is reversed from the order which would normally be expected (e.g., see the contents of buffer B 146), such that digits of less significance are placed in positions of greater significance, and digits of greater significance are placed in positions of lesser significance, prior to the execution of the various carry-free multiply and accumulate operations 136, 138, 140, and 144.

The process may conclude with calculating the most significant digit zₙ of the overall result Z, by taking the most significant 32-bit word of the temporary result buffer R (after the next-most significant digit of the overall result zᵢ=zₙ₋₁ 142 is determined by obtaining the least significant 32-bit word of the temporary result buffer R). It is emphasized that other psuedo-code and actual code implementations of the method illustrated in FIG. 1 may be effected, and are included within the scope of various embodiments of the invention.

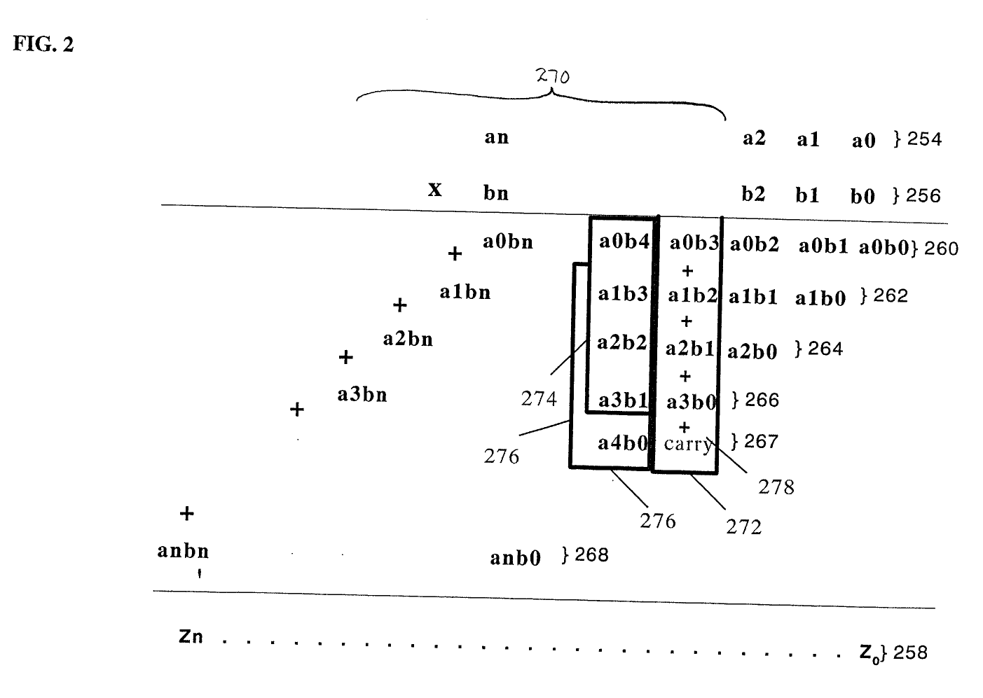

FIG. 2 is an exemplary diagram of two numbers being multiplied according to an embodiment of the invention. Herein are shown the partitioned multiplicand 254, multiplier 256, and the overall result 258. As the pseudo-code illustrated in FIG. 1 is implemented, various partial products are calculated, going across the rows 260, 262, 264, 266, 267, and 268, for example, perhaps using one or more SIMD-MAC instructions in the outer loop (referring to FIG. 1). In turn, resulting progressively packed partial products are multiplied and accumulated sequentially and vertically through the columns 270, in the inner loop (referring to FIG. 1), as shown for exemplary carry-free multiply and accumulate operations 272, 274, and 276. In one particular embodiment, the term “carry-free” means that carry operations 278 are well reserved with accumulator M (see buffer M 116 in FIG. 1), due to buffer M's size of 64 bits, although the scope of the invention is not limited in this respect. This eliminates the need for explicit operations to account for carry bits. Further, all multiplication and accumulation operations can be implemented within the size limitations of the target machine register size. Thus, the multiplication pipeline may be fully loaded during the entire carry-free multiplication process.

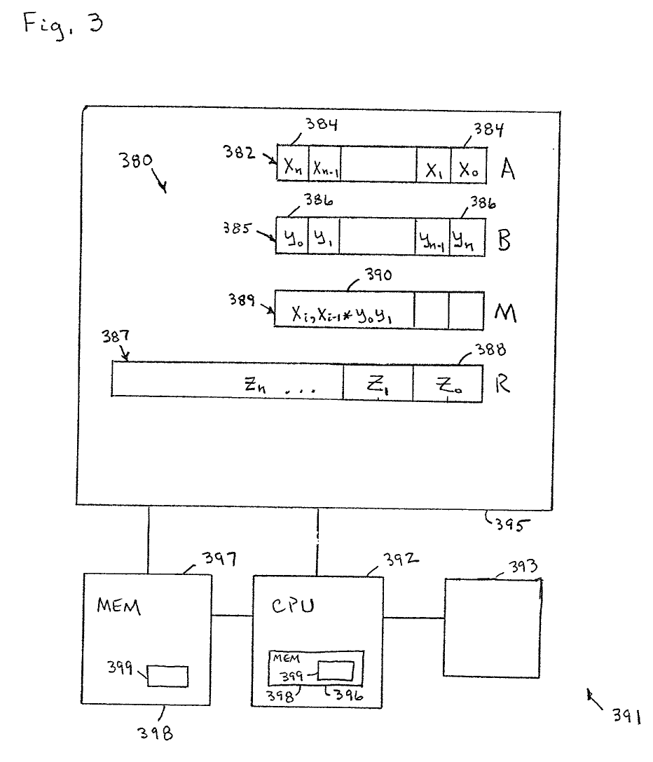

FIG. 3 is a block diagram of an apparatus, a system, and an article according to various embodiments of the invention. The apparatus 380 may include a multiplicand buffer 382 to hold one or more digits 384 of a multiplicand, a multiplier buffer 385 to hold one or more digits 386 of a multiplier, and a result buffer 387 to hold a carry-free multiplied and accumulated result 388 of the multiplicand X and a plurality of reverse ordered digits included in the multiplier Y, wherein the plurality of the reverse ordered digits includes the multiplier digits.

The result buffer 387 may have a number of bits equal to the number of bits included in the multiplicand buffer 382, added to the number of bits included in the multiplier buffer 385. The number of the plurality of reverse ordered digits 386 may be equal to the number of data bits in the result buffer 387 divided by the number of data bits included in each one of the plurality of reverse ordered digits 386 of the multiplier. For example, as noted above, the number of data bits included in each one of the plurality of reverse ordered digits 386 may be sixteen, while the number bits in the result buffer 387 may be sixty-four. The apparatus 380 may also include an accumulator buffer 389 to hold a carry-free multiplied and accumulated result 390 of one or more digits selected from the multiplicand and the multiplier.

In one particular embodiment, having buffers of adequate size for both the accumulator buffer 389 and the result buffer 387 eliminates the need to consider the effect of a carry operation, although the scope of the invention is not limited in this respect. To further elaborate, consider the case for computing the multiplication of two m-bit numbers where m=1024=2¹⁰, and the partitioned-digit fields are 16-bits wide. The total number of words to be processed would be N=1024/16=64. The largest possible value generated during the accumulation may then be (1024/16)*(4*(2¹⁶−1)*(2¹⁶−1))˜(2⁴⁰−1), which should be easily handled by the result and accumulation buffers 387, 389 of 64-bit size. Hence, generic Pentium® IV registers may be used to operate as accumulator buffers and/or result buffers in most cases. The same analysis shows that 64-bit accumulator registers are capable of m-bit multiplication, where m≦2³⁰, using multiplicand and multiplier partitioned-digit fields of 16-bit size (without causing carry overflow). As a result, it may be possible to achieve five-fold performance gains over conventional multiplication apparatus in many instances.

In another embodiment, a system 391 for conducting multiplication operations may include a processor 392 capable of being communicatively coupled to a co-processor 393 and a group of buffers 395. The co-processor 393 may be located on the same circuit board as the processor 392, or located remotely, as part of another apparatus or a peripheral. Typically the buffers 395 will be located on the same chip or die as the processor 392, however, the buffers 395 may also be located remotely; off-chip or even as part of another apparatus.

The processor 392 is capable of being communicatively coupled to a memory, either internal 396 or external 397, and is typically capable of executing single instruction, multiple data instructions, such as the SIMD_MAC instruction. The buffers 395 may include a multiplicand buffer 382 to hold one or more digits of a multiplicand, a multiplier buffer 385 to hold one or more digits of a multiplier, and a result buffer 387 to hold a carry-free multiplied and accumulated result 388 of the multiplicand X and a plurality of reverse ordered digits 386 included in the multiplier Y, wherein the plurality of the reverse ordered digits 386 includes one or more digits of the multiplier Y. The system 391 may also include an accumulator buffer 389 capable of being communicatively coupled to the processor 392. The accumulator buffer 389 may hold a carry-free multiplied and accumulated result 390 of the digit of the multiplicand and the digit of the multiplier. The number of bits included in the accumulator buffer 389 (as well as the number of bits in the multiplicand and the multiplier buffers 382, 385) may be equal to the number of bits included in the result buffer 387.

It should be noted that the apparatus 380; buffers 382, 385, 387, 389; processor 392; buffer group 395; and memories 396, 397 may all be characterized as “modules” herein. Such modules may include hardware circuitry, such as a microprocessor and/or memory circuits, software program modules, and/or firmware, and combinations thereof, as directed by the architect of the apparatus 380 and system 391, and appropriate for particular implementations of various embodiments of the invention.

One of ordinary skill in the art will understand that the apparatus and systems of various embodiments of the present invention can be used in applications other than those involving Pentium® processors, and thus, the invention is not to be so limited. The illustrations of an apparatus 380 and a system 391 are intended to provide a general understanding of the structure of various embodiments of the present invention, and are not intended to serve as a complete description of all the elements and features of apparatus and systems which might make use of the structures described herein.

Applications which may include the apparatus and systems of various embodiments of the present invention include electronic circuitry used in high-speed computers, communications and signal processing circuitry, processor modules, embedded processors, and application-specific modules, including multilayer, multi-chip modules. Such apparatus and systems may further be included as sub-components within a variety of electronic systems, such as televisions, video cameras, cellular telephones, personal computers, radios, vehicles, and others.

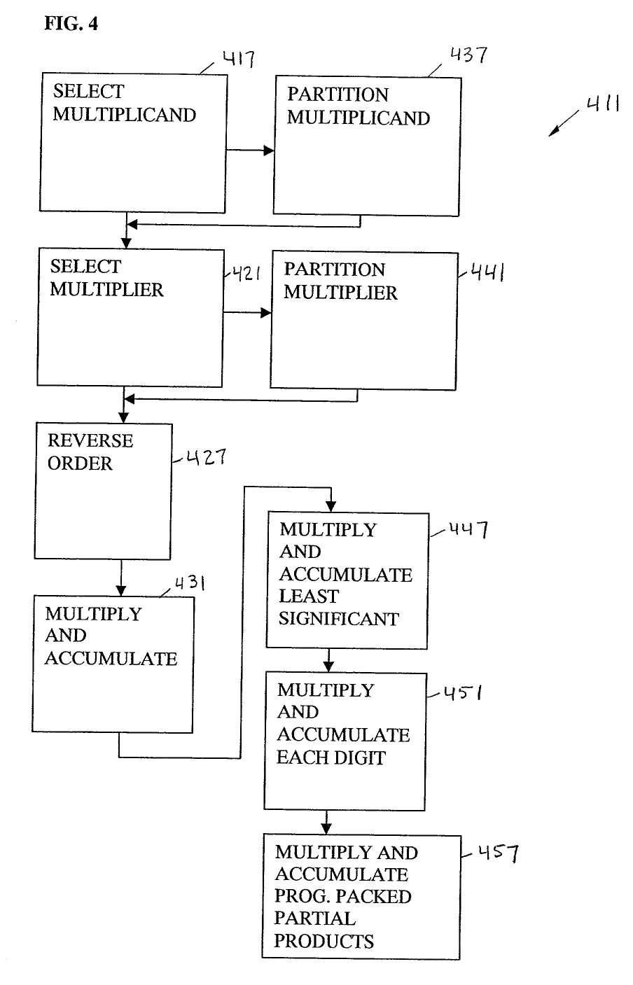

FIG. 4 is a flow diagram of a method of multiplication according to an embodiment of the invention. Generalizing from the pseudo-code example shown in FIG. 1, the method 411 may begin with selecting a multiplicand plurality of digits at block 417. The method 407 may also include selecting a multiplier plurality of digits at block 421, and then reversing the order of a selected multiplier plurality of digits to provide a reversed plurality of digits at block 427. The method may then continue with multiplying and accumulating the multiplicand plurality of digits and the reversed plurality of digits to provide a multiplication result at block 431. It should be noted that the multiplier and multiplicand have been identified throughout this document separately, as a matter of convenience. However, various embodiments of the invention may allow the multiplicand to be interchanged with the multiplier, such that either the multiplicand or the multiplier may include the reversed plurality of digits which are used for carry-free multiplication.

Selecting a multiplicand plurality of digits at block 417 may include partitioning the multiplicand into a multiplicand number of digits equal to a result buffer number of data bits divided by a multiplicand single digit buffer number of data bits at block 437. Selecting a multiplier plurality of digits at block 421 may include partitioning the multiplier into a selected multiplier plurality of digits equal to the multiplicand number of digits at block 441.

Multiplying and accumulating the multiplicand plurality of digits and the reversed plurality of digits to provide a multiplication result at block 431 may include multiplying and accumulating a least significant digit of the multiplicand plurality of digits and a least significant digit of the multiplier plurality of digits to provide a least significant digit of the multiplication result at block 447. The activity of block 431 may also include multiplying and accumulating a group of digits selected from the multiplicand plurality of digits and a group of digits selected from the reversed plurality of digits to provide a selected digit included in the multiplication result at block 451, which in turn may include multiplying and accumulating progressively packed partial products of a group of digits selected from the multiplicand plurality of digits and progressively packed partial products of a group of digits selected from the reversed plurality of digits at block 457. Each digit of the multiplicand plurality of digits may have a number of bits equal to the number of bits in each digit of the multiplier plurality of digits. And all of the multiplication and accumulation operations may include using a program instruction similar to, or identical to a SIMD_MAC program instruction.

It should be noted that while SIMD-MAC programs instructions have been used as an example of multiplication and accumulation operational elements herein, other mechanisms operating on a similar or identical fashion may also be used according to various embodiments of the invention, and therefore, the invention is not to be so limited. Therefore, it should be clear that some embodiments of the present invention may also be described in the context of computer-executable instructions, such as program modules, being executed by a computer. Generally, program modules may include routines, programs, objects, components, data structures, etc. that perform particular tasks or implement particular abstract data types.

Thus, referring back to FIG. 3, an article 398 according to an embodiment of the invention can be seen. One of ordinary skill in the art will understand, upon reading and comprehending this disclosure, the manner in which a software program can be launched from a computer readable medium in a computer based system to execute the functions defined in the software program. One of ordinary skill in the art will further understand the various programming languages which may be employed to create a software program designed to implement and perform the methods of the present invention. The programs can be structured in an object-orientated format using an object-oriented language such as Java, Smalltalk, or C++. Alternatively, the programs can be structured in a procedure-orientated format using a procedural language, such as COBOL or C. The software components may communicate using any of a number of mechanisms that are well-known to those skilled in the art, such as Application Program Interfaces (APIs) or interprocess communication techniques. However, as will be appreciated by one of ordinary skill in the art upon reading this disclosure, the teachings of various embodiments of the present invention are not limited to any particular programming language or environment.

As is evident from the preceding description, the processor 392 typically accesses at least some form of computer-readable media, such as the internal memory 396, and/or the external memory 397. However, computer-readable and/or accessible media may be any available media that can be accessed by the apparatus 380, processor 392, and/or the system 391.

By way of example and not limitation, computer-readable media may comprise computer storage media and communications media. Computer storage media includes volatile and non-volatile, removable and non-removable media implemented using any method or technology for storage of information such as computer-readable instructions, data structures, program modules or other data. Communication media specifically embodies computer-readable instructions, data structures, program modules or other data present in a modulated data signal such as a carrier wave, coded information signal, and/or other transport mechanism, which includes any information delivery media. The term “modulated data signal” means a signal that has one or more of its characteristics set or changed in such a manner as to encode information in the signal. By way of example and not limitation, communications media also includes wired media such as a wired network or direct-wired connections, and wireless media such as acoustic, optical, radio frequency, infrared and other wireless media. Combinations of any of the above are also be included within the scope of computer-readable and/or accessible media.

Thus, referring to FIG. 3, it is now understood that another embodiment of the invention may include an article 398 comprising a machine-accessible medium 396, 397 having associated data 399, wherein the data 399, when accessed, results in the machine 392 performing activities such as selecting a multiplicand plurality of digits, reversing the order of the selected multiplier plurality of digits to provide a reversed plurality of digits, and multiplying and accumulating the multiplicand plurality of digits and the reversed plurality of digits to provide a multiplication result, which may in turn include multiplying and accumulating using a single instruction, multiple data program instruction.

Other activities may include multiplying and accumulating a least significant digit of the multiplicand plurality of digits and a least significant digit of the multiplier plurality of digits to provide a least significant digit of the multiplication result. As noted above, each digit of the multiplicand plurality of digits may have a number of bits equal to a number of bits in each digit of the multiplier plurality of digits.

Various embodiments of the invention may provide a performance advantage over more traditional approaches because the addition of cross-multiplication results can occur in a carry-free (i.e., no explicit carry operation necessary) fashion. The execution parallelism offered by such multiply and accumulate operations provides an opportunity to continuously feed data into multiplication sequence pipelines without conventional interruptions due to carry propagation.

Although specific embodiments have been illustrated and described herein, those of ordinary skill in the art will appreciate that any arrangement which is calculated to achieve the same purpose may be substituted for the specific embodiments shown. This disclosure is intended to cover any and all adaptations or variations of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of embodiments of the invention includes any other applications in which the above structures and methods are used. The scope of embodiments of the invention should be determined with reference to the appended claims, along with the fall range of equivalents to which such claims are entitled.

It is emphasized that the Abstract is provided to comply with 37 C.F.R. §1.72(b) requiring an Abstract that allows a reader to ascertain the nature of the technical disclosure. It is submitted with the understanding that it will not be used to interpret or limit the scope or meaning of the claims. In addition, even though various features have been grouped together in a single embodiment for the purpose of streamlining the disclosure, it should be noted that inventive subject matter lies in less than all features of a single disclosed embodiment. Thus the following claims are hereby incorporated into the Detailed Description of Embodiments of the Invention, with each claim standing on its own as an alternative embodiment.

What is claimed is:

1. An apparatus, comprising:
a multiplicand buffer to hold a digit of a multiplicand;
a multiplier buffer to hold a digit of a multiplier; and
a result buffer to hold a carry-free multiplied and accumulated result of the multiplicand and a plurality of reverse ordered digits included in the multiplier, wherein the plurality of the reverse ordered digits includes the digit of the multiplier.

2. The apparatus of claim 1, further comprising:
an accumulator buffer to hold a carry-free multiplied and accumulated result of the digit of the multiplicand and the digit of the multiplier.

3. The apparatus of claim 1, wherein the result buffer has a number of bits which is equal to a number of bits included in the multiplicand buffer added to a number of bits included in the multiplier buffer.

4. The apparatus of claim 1, wherein a number of the plurality of reverse ordered digits is equal to a result buffer number of data bits divided by a number of data bits included in each one of the plurality of reverse ordered digits.

5. The apparatus of claim 4, wherein the number of data bits included in each one of the plurality of reverse ordered digits is sixteen.

6. The apparatus of claim 5, wherein the number of result buffer data bits is sixty-four.

7. A system, comprising:
a processor capable of executing a single instruction, multiple data instruction; and
a group of buffers communicatively coupled to the processor, including a multiplicand buffer to hold a digit of a multiplicand, a multiplier buffer to hold a digit of a multiplier, and a result buffer to hold a carry-free multiplied and accumulated result of the multiplicand and a plurality of reverse ordered digits included in the multiplier, wherein the plurality of the reverse ordered digits includes the digit of the multiplier.

8. The system of claim 7, further comprising:
an accumulator buffer communicatively coupled to the processor, the accumulator buffer to hold a carry-free multiplied and accumulated result of the digit of the multiplicand and the digit of the multiplier.

9. The system of claim 8, wherein a number of bits included in the accumulator buffer is equal to a number of bits included in the result buffer.

10. The system of claim 7, wherein a number of bits included in the multiplicand buffer is equal to a number of bits included in the result buffer.

11. The system of claim 7, further comprising:
a co-processor capable of being communicatively coupled to the processor.

12. A method, comprising:
selecting a multiplicand plurality of digits;
reversing the order of a selected multiplier plurality of digits to provide a reversed plurality of digits; and
multiplying and accumulating the multiplicand plurality of digits and the reversed plurality of digits to provide a multiplication result.

13. The method of claim 12, wherein selecting a multiplicand plurality of digits further comprises:
partitioning a multiplicand into a multiplicand number of digits equal to a result buffer number of data bits divided by a multiplicand single digit buffer number of data bits.

14. The method of claim 13, further comprising:
partitioning a multiplier into the selected multiplier plurality of digits equal to the multiplicand number of digits.

15. The method of claim 12, wherein multiplying and accumulating the multiplicand plurality of digits and the reversed plurality of digits to provide a multiplication result further comprises:
multiplying and accumulating a group of digits selected from the multiplicand plurality of digits and a group of digits selected from the reversed plurality of digits to provide a selected digit included in the multiplication result.

16. The method of claim 15, wherein multiplying and accumulating a group of digits selected from the multiplicand plurality of digits and a group of digits selected from the reversed plurality of digits to provide a selected digit included in the multiplication result further comprises:
multiplying and accumulating progressively packed partial products of a group of digits selected from the multiplicand plurality of digits and progressively packed partial products of a group of digits selected from the reversed plurality of digits.

17. An article comprising a machine-accessible medium having associated data, wherein the data, when accessed, results in a machine performing:
selecting a multiplicand plurality of digits;
reversing the order of a selected multiplier plurality of digits to provide a reversed plurality of digits; and
multiplying and accumulating the multiplicand plurality of digits and the reversed plurality of digits to provide a multiplication result.

18. The article of claim 17, wherein the machine-accessible medium further includes data, which when accessed by the machine, results in the machine performing:
multiplying and accumulating a least significant digit of the multiplicand plurality of digits and a least significant digit of the multiplier plurality of digits to provide a least significant digit of the multiplication result.

19. The article of claim 18, wherein each digit of the multiplicand plurality of digits has a number of bits equal to a number of bits in each digit of the multiplier plurality of digits.

20. The article of claim 17, wherein multiplying and accumulating the multiplicand plurality of digits and the reversed plurality of digits to provide a multiplication result further comprises:
multiplying and accumulating using a single instruction, multiple data program instruction.
